(19) United States
(12) Patent Application Publication
(10) Pub. No.: US 2019/0020226 A1
(43) Pub. Date: Jan. 17, 2019

(54) WIRELESS CHARGING DEVICE AND WIRELESS CHARGING METHOD THEREOF

(71) Applicant: BOE TECHNOLOGY GROUP CO., LTD., Beijing (CN)

(72) Inventors: Zicheng HUANG, Beijing (CN); Liang LI, Beijing (CN)

(21) Appl. No.: 15/941,792

(22) Filed: Mar. 30, 2018

(30) Foreign Application Priority Data
Jul. 14, 2017 (CN) 201710577346.1

(51) Int. Cl. H02J 50/90; H02J 7/02; H02J 50/10; H02J 7/00

(52) U.S. Cl. CPC H02J 50/90; H02J 7/025; H05B 33/0845; H02J 7/0047; H02J 50/10

(57) ABSTRACT

A wireless charging device and a wireless charging method thereof are provided. The wireless charging device includes a carrying platform configured to place a terminal equipment; a plurality of magnetic field detection sensors distributed on a plane parallel to a bearing surface of the carrying platform, and the plurality of magnetic field detection sensors being configured to detect a change value of a magnetic field intensity generated by a first charging coil of the terminal equipment; a position indicator configured to indicate a position of the first charging coil; a controller, connected to both the position indicator and the plurality of magnetic field detection sensors, and the controller being configured to determine the position of the first charging coil according to the change value of the magnetic field intensity, and to control the position indicator to indicate the position of the first charging coil; and a second charge coil.

### CROSS-REFERENCE TO RELATED APPLICATION

This application claims priority to Chinese Patent Application No. 201710577346.1, filed on Jul. 14, 2017, titled “WIRELESS CHARGING DEVICE AND WIRELESS CHARGING METHOD THEREOF”, which is incorporated herein by reference in its entirety.

### TECHNICAL FIELD

The present disclosure relates to the wireless charging technology field, more particularly, to a wireless charging device and a wireless charging method thereof.

### BACKGROUND

In recent years, with the continuous development of science and technology, various terminal devices have gradually appeared in people's daily lives and have become an indispensable part of daily lives of modern people. A traditional charging method is that different terminal devices rely on their matching charging lines for charging, and such wired charging method is cumbersome and may not satisfy the charging requirements of modern people, so wireless charging devices have emerged.

### SUMMARY

On one hand, some embodiments of the present disclosure provide a wireless charging device. The wireless charging device includes: a carrying platform configured to place a terminal equipment to be charged; a plurality of magnetic field detection sensors distributed on a plane parallel to a bearing surface of the carrying platform, wherein the plurality of magnetic field detection sensors being configured to detect a change value of a magnetic field intensity generated by a first charging coil of the terminal equipment to be charged; a position indicator configured to indicate a position of the first charging coil; a controller connected to both the position indicator and the plurality of magnetic field detection sensors, and the controller being configured to determine the position of the first charging coil according to the change value of the magnetic field intensity detected by the plurality of magnetic field detection sensors and to control the position indicator to indicate the position of the first charging coil; and a second charge coil.

In some embodiments of the present disclosure, the position indicator includes a position indication layer disposed on the bearing surface of the carrying platform, and a position of the position indication layer corresponds to a position of the plurality of magnetic field detection sensors.

Further, in some embodiments of the present disclosure, the position indication layer includes a plurality of LED lamps, and a position of the plurality of LED lamps correspond to the position of the plurality of magnetic field detection sensors.

In some embodiments of the present disclosure, the controller is further configured to control a brightness of light emitted from the plurality of LED lamps according to the change value of the magnetic field intensity detected by the plurality of magnetic field detection sensors.

In some embodiments of the present disclosure, the controller is further configured to calculate a center position of the first charging coil according to the change value of the magnetic field intensity detected by the plurality of magnetic field detection sensors, and to control the position indicator to indicate the center position of the first charging coil.

In some embodiments of the present disclosure, the wireless charging device further includes a power supply; wherein the power supply and the second charging coil are both connected to the controller, and the controller is further configured to control a turning-on and a turning-off of a control switch connected between the power supply and the second charging coil and to control a magnitude of a current output from the power supply to the second charging coil.

Further, in some embodiments of the present disclosure, the power supply includes a polymer battery.

In some embodiments of the present disclosure, the wireless charging device further includes a detector connected to the controller, and the detector is configured to detect whether the terminal equipment to be charged is placed on the carrying platform; if the terminal equipment to be charged is placed on the carrying platform, the controller controls the control switch connected between the power supply and the second charging coil to be turned on.

In some embodiments of the present disclosure, a marker is provided on the bearing surface of the carrying platform, and the marker is configured to indicate a position of the second charging coil.

On another hand, some embodiments of the present disclosure provide a wireless charging method for a wireless charging device provided in the above embodiments. The wireless charging method includes: detecting a change value of a magnetic field intensity generated by a first charging coil of a terminal equipment to be charged; determining a position of the first charging coil according to the change value of the magnetic field intensity; and indicating the position of the first charging coil.

In some embodiments of the present disclosure, a step of detecting the change value of the magnetic field intensity generated by the first charging coil of the terminal equipment to be charged includes: detecting the change value of the magnetic field intensity generated by the first charging coil in a case that a second charging coil of the wireless charging device is not energized.

In some embodiments of the present disclosure, a step of determining the position of the first charging coil according to the change value of the magnetic field intensity includes: determining a center position of the first charging coil according to the change value of the magnetic field intensity; and a step of indicating the position of the first charging coil includes: indicating the center position of the first charging coil.

In some embodiments of the present disclosure, the above wireless charging method may further include: detecting whether the terminal equipment to be charged is placed on the carrying platform of the wireless charging device; and controlling the second charging coil to be energized in a case that the terminal equipment to be charged is placed on the carrying platform.

### BRIEF DESCRIPTION OF THE DRAWINGS

In order to describe technical solutions in embodiments of the present disclosure more clearly, the accompanying drawings to be used in the description of embodiments will be introduced briefly. Obviously, the accompanying drawings to be described below are merely some embodiments of the present disclosure, and a person of ordinary skill in the art can obtain other drawings according to those drawings without paying any creative effort.

FIG. 1 is a first schematic structural diagram of a wireless charging device according to some embodiments of the present disclosure.

FIG. 2 is a schematic structural diagram of a magnetic field generated by a first charging coil according to some embodiments of the present disclosure.

FIG. 3 is a second schematic structural diagram of a wireless charging device according to some embodiments of the present disclosure.

FIG. 4 is a third schematic structural diagram of a wireless charging device according to some embodiments of the present disclosure.

FIG. 5 is a schematic diagram of principles of wireless charging performed by a wireless charging device according to some embodiments of the present disclosure.

FIG. 6 is a fourth schematic structural diagram of a wireless charging device according to some embodiments of the present disclosure.

FIG. 7 is a fifth schematic structural diagram of a wireless charging device according to some embodiments of the present disclosure.

FIG. 8 is a schematic flowchart of a wireless charging method of a wireless charging device according to some embodiments of the present disclosure.

### DETAILED DESCRIPTION

The technical solutions in the embodiments of the present disclosure will be described clearly and completely with reference to the drawings in the embodiments of the present disclosure. Obviously, the described embodiments are merely some but not all of embodiments of the present disclosure. All other embodiments made on the basis of the embodiments of the present disclosure by a person of ordinary skill in the art without paying any creative effort shall be included in the protection scope of the present disclosure.

A wireless charging technology is a technology that receives an electromagnetic wave emitted by a wireless charging coil of a wireless charging device through the wireless charging coil of a terminal device, and uses an inductive energy transmission of a low-frequency electromagnetic wave to enable the terminal device to obtain electrical energy so as to complete a charging. However, since positions of the wireless charging coils of various wirelessly chargeable terminal devices are not uniform, and not all of the wireless charging coils of the terminal devices are located at a center position of the terminal device. Therefore, it is difficult to align the wireless charging coil of the wireless charging device when the wireless charging is performed, resulting in inconvenient and not user-friendly when the existing wireless charging device is used.

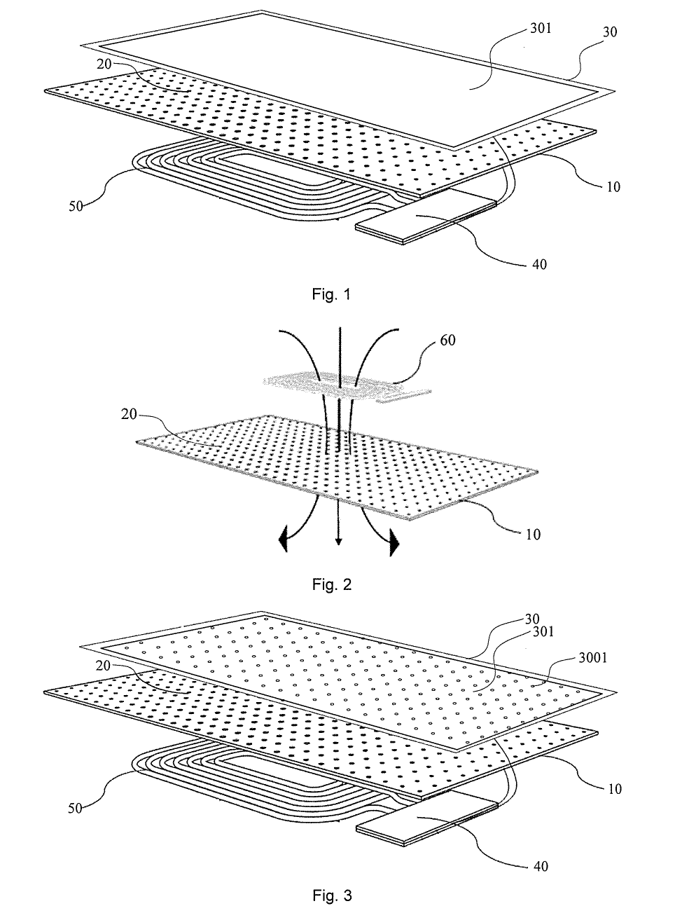

Some embodiments of the present disclosure provide a wireless charging device. As shown in FIG. 1, the wireless charging device includes a carrying platform 10, a plurality of magnetic field detection sensors 20, a position indicator 30, a controller 40 and a second charging coil 50. The carrying platform 10 is configured to place a terminal equipment to be charged. Illustratively, the terminal equipment to be charged may be a wirelessly chargeable electronic product such as a mobile phone or a tablet computer. The plurality of magnetic field detection sensors 20 are distributed on a plane parallel to a bearing surface of the carrying platform 10. The plurality of magnetic field detection sensors 20 are configured to detect a change value of a magnetic field intensity generated by a first charging coil of the terminal equipment to be charged. The position indicator 30 is configured to indicate a position of the first charging coil. The controller 40 is connected to both the position indicator 30 and the plurality of magnetic field detection sensors 20. The controller 40 is configured to determine the position of the first charging coil based on a change value of the magnetic field intensity detected by the plurality of magnetic field detection sensors 20, and control the position indicator 30 to indicate the position of the first charging coil.

It should be noted that, firstly, the plurality of magnetic field detection sensors 20 are distributed on the plane parallel to the bearing surface of the carrying platform 10. The plurality of magnetic field detection sensors 20 may be distributed on the carrying platform 10, or the plurality of magnetic field detection sensors 20 may be distributed on other substrates parallel to the bearing surface of the carrying platform 10. When the plurality of magnetic field detection sensors 20 are distributed on the carrying platform 10, the plurality of magnetic field detection sensors 20 may be distributed on the carrying surface of the carrying platform 10 as shown in FIG. 1, or may be distributed on a surface opposite to the carrying surface of the carrying platform 10 (the drawings of the present disclosure are not illustrated).

Here, since the earth or other products may also generate the magnetic field, even if the terminal equipment to be charged is not placed above the carrying platform 10, the plurality of magnetic field detection sensors 20 can detect the magnetic field. As shown in FIG. 2, when the terminal equipment to be charged is placed above the carrying platform 10, the magnetic field generated by the first charging coil 60 generates has a specific regularity different from other natural magnetic fields. The magnetic field generated by the first charging coil 60 makes the magnetic field intensity at the plurality of magnetic field detection sensors 20 change. Therefore, the plurality of magnetic field detection sensors 20 can detect the change value of the magnetic field intensity generated by the first charging coil 60. The magnetic field intensity generated by the first charging coil 60 can be deduced from the magnetic field intensity when the terminal equipment to be charged is not placed and the change value of the magnetic field.

Principles of detecting the change value of the magnetic field intensity by the plurality of magnetic field detection sensors 20 are specifically that the plurality of magnetic field detection sensors 20 is a layer of magnetic thin film principles of magnetoresistance effect, and a resistance of the magnetic thin film changes with the change of the magnetic field intensity. The correspondence between the magnetic field intensity and the resistance is:

$$\frac{Δ ρ}{ρ} {∞H}^{2} {μ}^{2} ;$$

wherein, Δ ρ is a change value of the resistance, p is a value of the resistance, H is a value of the magnetic field intensity, and μ is a coefficient. The change value of magnetic field intensity can be calculated by detecting the change of the resistance of the magnetic thin film.

In addition, as for the number of the plurality of magnetic field detection sensors 20, it depends on whether they can accurately detect the change value of the magnetic field intensity generated by the first charging coil 60 of the terminal equipment to be charged. Based on this, the plurality of magnetic field detection sensors 20 can be integrated on one substrate.

Second, for the position indicator 30, the position indicator 30 may include a display screen. When the plurality of magnetic field detection sensors 20 detects the first charging coil 60, the position indicator 30 displays an image at a position corresponding to the first charging coil 60, for example, displays a coil. The position indicator 30 may also include a plurality of indicator lamps. Some of the plurality of indicator lamps which are located at a position corresponding to the first charging coil 60 emit light. Of course, the position indicator 30 may also use other various ways to prompt how to move the first charging coil 60 so that the first charging coil 60 is located at an optimal charging position. For example, the position of the first charging coil 60 is indicated by a voice prompt. In some embodiments of the present disclosure, after the plurality of magnetic field detection sensors 20 detect the position of the first charging coil 60, the controller 40 prompts the movement direction of the charging coil 60 through the voice prompt according to the position of the first charging coil 60 and the position of the second charging coil 50, such as prompts the charging coil 60 to move left, move right, and so on. For another example, the position indicator 30 may include a plurality of indicator lights, and the plurality of indicator lights may compose an arrow shape to indicate the first charging coil 60 to move to the optimal charging position.

Third, in some embodiments of the present disclosure, controller 40 is a control circuit board.

Fourth, the position of the first charge coil 60 can be obtained by the detection of the plurality of magnetic field detection sensors 20. In some embodiments of the present disclosure, in order to facilitate the alignment of the first charging coil 60 and the second charging coil 50, a position of the second charging coil 50 is marked on the bearing surface of the carrying platform 10, or the position of the second charging coil 50 is fixed corresponding to a certain position of the carrying platform 10, such as a center position of the carrying platform 10, so that the first charging coil 60 can be aligned with the second charging coil 50 only by moving the first charging coil 60 to the center of the carrying platform 10.

In the wireless charging device provided in the embodiments of the present disclosure, since the plurality of magnetic field detection sensors 20 are distributed on the plane parallel to the bearing surface of the carrying platform 10, after the terminal equipment to be charged is placed above the carrying platform 10, the first charging coil 60 generates the magnetic field, and the plurality of magnetic field detection sensors 20 may detect the change value of the magnetic field intensity generated by the first charging coil 60. The controller 40 may determine the position of the first charging coil 60 based on the change value of the magnetic field intensity detected by the plurality of magnetic field detection sensors 20, and control the position indicator 30 to indicate the position of the first charging coil 60. In this way, it is easy for users to determine the position of the first charging coil 60 according to an indication of the position indicator 30, and thus easily aligning the second charging coil 50 with the first charging coil 60. Based on this, the alignment of the second charging coil 50 and the first charging coil 60 can also improve the charging efficiency of the wireless charging device.

In some embodiments of the present disclosure, as shown in FIG. 1, the position indicator 30 includes a position indication layer 301 disposed on the bearing surface of the carrying platform 10, and a position of the position indication layer 301 corresponding to a position of the plurality of magnetic field detection sensors 20.

In some embodiments of the present disclosure, the position indication layer 301 is a display screen or a plurality of indicator lamps.

In some embodiments of the present disclosure, the position indication layer 301 is provided at a position of the bearing surface of the carrying platform 10 corresponding to the plurality of magnetic field detection sensors 20. After the magnetic field detecting sensor 20 detects the position of the first charging coil 60, the position indication layer 301 may indicate the position of the first charging coil 60 corresponding to the bearing surface of the carrying platform 10. In this way, the users can intuitively see the position of the first charging coil 60 so as to align the first charging coil 60 with the second charging coil 50.

Further, in some embodiments of the present disclosure, as shown in FIG. 3, the position indication layer 301 includes a plurality of LED (Light Emitting Diode) lamps 3001, and a position of the plurality of LED lamps 3001 corresponds to the position of the plurality of magnetic field detection sensors 20.

When the terminal equipment to be charged is placed above the carrying platform 10 of the wireless charging device, the magnetic field generated by the first charging coil 60 may affect the change of the magnetic field intensity at the plurality of magnetic field detection sensors 20. Since the position of the plurality of LED lamps 3001 corresponds to the position of the plurality of magnetic field detection sensors 20, the controller 40 may control the plurality of LED lamps 3001 to emit light according to the change value of the magnetic field intensity of the plurality of magnetic field detection sensors 20, thereby indicating the position of the first charging coil 60.

Since the plurality of LED lamps 3001 are simple in structure and inexpensive, in some embodiments of the present disclosure, the position indication layer 301 includes the plurality of LED lamps 3001.

It should be noted that, since the magnetic field intensity of the magnetic field generated by a center position of a charging coil is the maximum, the controller 40 is also configured to control the brightness of light emitted from the plurality of LED lamps 3001 according to the change value of the magnetic field intensity detected by the plurality of magnetic field detection sensors 20 when the position indication layer 301 includes the plurality of LED lamps 3001. For example, the greater the change value of magnetic field intensity is, the greater the brightness of light emitted by the plurality of LED lamps 3001 is. In this way, the users may determine a center position of the first charging coil 60 according to the brightness of the plurality of LED lamps 3001, and thus quickly align the center position of the first charging coil 60 with a center position of the second charging coil 50.

In some embodiments of the present disclosure, the controller 40 is further configured to calculate the center position of the first charging coil 60 based on the change value of the magnetic field intensity detected by the plurality of magnetic field detection sensors 20, and to control the position indicator 30 to indicate the center position of the first charging coil 60.

Here, the controller 40 may calculate a magnetic field range and a distribution of the magnetic field intensity generated by the first charging coil 60 according to the change value of the magnetic field intensity detected by the plurality of magnetic field detection sensors 20. The center position of the first charging coil 60 may be deduced by using the geometric method according to the magnetic field range, or the position where a maximum value of the magnetic field intensity is located may be determined by the distribution of the magnetic field intensity, that is, the center position of the first charging coil 60 may be obtained.

In some embodiments of the present disclosure, only the center position of the first charging coil 60 is indicated by the position indicator 30, thus a power consumption of the wireless charging device can be reduced comparing with the entire first charging coil 60 being indicated. Based on this, only the center position of the first charging coil 60 is indicated, so as long as the center position of the first charging coil 60 is aligned with the center position of the second charging coil 50, it is easier to align the first charging coil 60 of the terminal equipment to be charged with the second charging coil 50 of the wireless charging device.

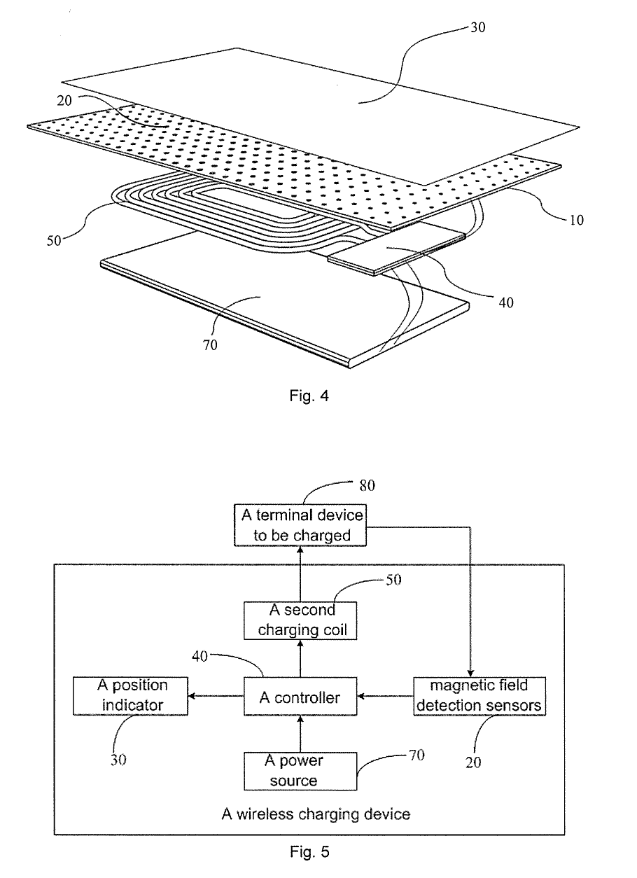

In some embodiments of the present disclosure, as shown in FIG. 4, the wireless charging device further includes a power supply 70. Both the power supply 70 and the second charging coil 50 are connected to the controller 40. The controller 40 is also configured to control a turning-on and a turning-off of a control switch connected between the power supply 70 and the second charging coil 50 and to control a magnitude of a current output from the power supply 70 to the second charging coil 50.

In some embodiments of the present disclosure, the power supply 70 includes an adaptation component. The adaptation component is configured to convert an alternating current into a direct current. Alternatively, in still other embodiments of the present disclosure, the power supply 70 is a battery. Optionally, the power supply 70 is a polymer battery.

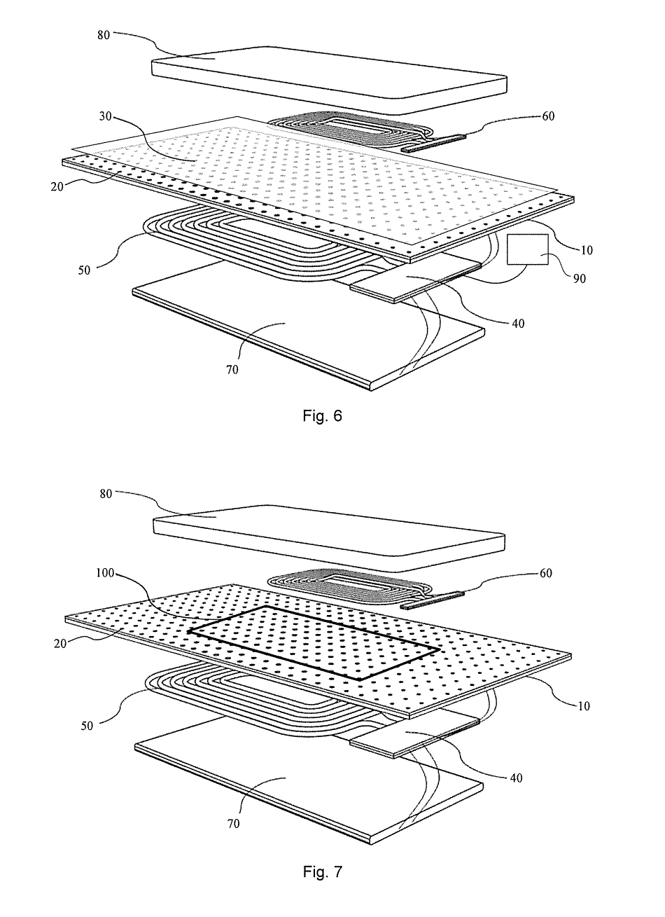

A schematic diagram of principles of wireless charging performed by the wireless charging device is shown in FIG. 5. The plurality of magnetic field detection sensors 20 detects the change value of the magnetic field intensity generated by the first charging coil 60 of the terminal equipment to be charged 80. The controller 40 controls the position indicator 30 to indicate the position of the first charging coil 60 based on the detection results of the plurality of magnetic field detection sensors 20. The position of the first charging coil 60 is adjusted according to the position of the second charging coil 50 so that the first charging coil 60 and the second charging coil 50 are aligned with each other. After that, the controller 40 controls the control switch connected between the power supply 70 and the second charging coil 50 to be turned on. After the second charging coil 50 is energized, the second charging coil 50 generates the magnetic field so that the first charging coil 60 of the terminal equipment to be charged 80 may be charged.

In some embodiments of the present disclosure, the power supply 70 supplies electricity to the second charging coil 50 when the controller 40 controls the control switch connected between the power supply 70 and the second charging coil 50 to be turned on, and the second charging coil 50 generates the magnetic field. Thus, the first charging coil 60 can be charged. The larger the current output from the power supply 70 to the second charging coil 50 is, the higher the charging efficiency of the second charging coil 50 is. Therefore, the magnitude of the current output from the power supply 70 to the second charging coil 50 can be controlled as required.

It should be noted that, in order to prevent the magnetic field generated by the second charging coil 50 from affecting the plurality of magnetic field detection sensors 20 to detect the magnetic field intensity generated by the first charging coil 60 in the process of aligning the first charging coil 60 with the second charging coil 50, the control switch connected between the power supply 70 and the second charging coil 50 may be controlled to be turned off by the controller 40 in the process of aligning the first charging coil 60 with the second charging coil 50.

Based on the above, in some embodiments of the present disclosure, as shown in FIG. 6, the wireless charging device further includes a detector 90. The detector 90 is connected to the controller 40. The detector 90 is configured to detect whether the terminal equipment to be charged 80 is placed on the carrying platform 10. If the terminal equipment to be charged 80 is placed on the carrying platform 10, the controller 40 controls the control switch connected between the power supply 70 and the second charging coil 50 to be turned on.

It should be noted that, in the embodiments of the present disclosure, a type of the detector 90 is not limited. For example, the detector 90 may be a gravity detection sensor, a distance measurement sensor, or the like.

In some embodiments of the present disclosure, after the first charging coil 60 is aligned with the second charging coil 50, the terminal equipment to be charged 80 is placed on the carrying platform 10 to charge. In this way, when the detector 90 detects that the terminal equipment to be charged 80 is placed on the carrying platform 10 of the wireless charging device, the controller 40 may directly control the control switch connected between the power supply 70 and the second charging coil 50 to be turned on without manually turning on the control switch connected between the power supply 70 and the second charging coil 50, thereby realizing an intelligentization of the wireless charging device and improving the satisfaction of the users.

In some embodiments of the present disclosure, as shown in FIG. 7, a marker 100 is provided on the bearing surface of the carrying platform 10, and the marker 100 is configured to indicate the position of the second charging coil 50.

The marker 100 may be an indicator lamp, or may be a marker line as shown in FIG. 6.

Here, it should be noted that, when the plurality of magnetic field detection sensors 20 or the position indicator 30 are further provided on the bearing surface of the carrying platform 10, the marker 100 should be set at the top.

In the embodiments of the present disclosure, the position of the second charging coil 50 can be accurately known according to the marker 100 on the bearing surface of the carrying platform 10. When the position indicator 30 indicates the position of the first charging coil 60, it is more advantageous to adjust the position of the terminal equipment to be charged according to the marker 100, and thus it is able to quickly align the first charging coil 60 with the second charging coil 50.

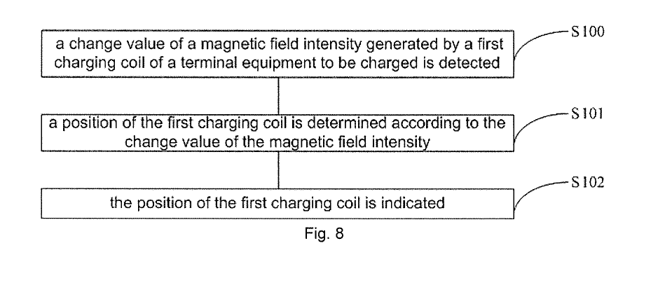

Still other embodiments of the present disclosure provide a wireless charging method of the wireless charging device described above. As shown in FIG. 8, the wireless charging method includes the following steps 100˜102 (S100˜S102).

In S100, a change value of a magnetic field intensity generated by a first charging coil 60 of a terminal equipment to be charged 80 is detected.

Illustratively, a plurality of magnetic field detection sensors 20 may be used to detect the change value of the magnetic field intensity generated by the first charging coil 60. Here, when the terminal equipment to be charged 80 is placed over the carrying platform 10 of the wireless charging device, the magnetic field generated by the first charging coil 60 will cause the magnetic field intensity at the plurality of magnetic field detection sensors 20 to change.

It should be noted that, the second charging coil 50 may be energized to generate a magnetic field in the second charging coil 50, and the second charging coil 50 may not be energized.

In S101, a position of the first charging coil 60 is determined according to the change value of the magnetic field intensity.

Here, since the first charge coil 60 generates the magnetic field, the magnetic field intensity at the position corresponding to the first charge coil 60 changes, and thus the position of the first charge coil 60 can be determined based on the change value of the magnetic field intensity.

In S102, the position of the first charging coil 60 is indicated.

In the embodiments of the present disclosure, the manner of indicating the position of the first charging coil 60 is not limited. The position of the first charging coil 60 may be indicated by an indicator light or displaying an image, of course, it may be indicated by voice.

In the wireless charging method of the wireless charging device provided in the embodiments of the present disclosure, since the terminal equipment to be charged is placed above the carrying platform 10, the first charging coil 60 will generate the magnetic field, and the position of the first charging coil 60 may be determined and indicated according to the change value of the magnetic field intensity generated by the first charging coil 60. In this way, the users can easily determine the position of the first charging coil 60 according to this instruction, so that it is easy to align the second charging coil 50 with the first charging coil 60. Based on this, the alignment of the second charging coil 50 and the first charging coil 60 may also improve the charging efficiency of the wireless charging device.

In some embodiments of the present disclosure, steps of detecting the change value of the magnetic field intensity generated by the first charging coil 60 of the terminal equipment to be charged 80 include: the change value of the magnetic field intensity generated by the first charging coil 60 is detected in a case that a second charging coil 50 of the wireless charging device is not energized.

In the embodiments of the present disclosure, the second charging coil 50 does not generate a magnetic field when the second charging coil 50 of the wireless charging device is not energize, so that it is able to prevent the magnetic field generated by the second charging coil 50 from affecting the magnetic field detection sensors 20 to detect the change value of the magnetic field intensity generated by the first charging coil 60, and thereby the determined position of the first charging coil 60 based on the detected change value of the magnetic field intensity is more accurate.

In some embodiments of the present disclosure, S101 specifically includes: a center position of the first charging coil 60 is determined according to the change value of the magnetic field intensity.

Here, a magnetic field range and a distribution of the magnetic field intensity generated by the first charging coil 60 may be calculated from the change value of the magnetic field intensity. A center position of the first charging coil 60 may be deduced by using the geometric method according to the magnetic field range, or the position where a maximum value of the magnetic field intensity is located may be determined by the distribution of the magnetic field intensity, that is, the center position of the first charging coil 60 may be obtained.

S102 specifically includes: the center position of the first charging coil 60 is indicated.

In some embodiments of the present disclosure, only the center position of the first charging coil 60 is indicated, a power consumption of the wireless charging device can be reduced comparing with the entire first charging coil 60 being indicated. Based on this, only the center position of the first charging coil 60 is indicated, so as long as the center position of the first charging coil 60 is aligned with the center position of the second charging coil 50, it is easier to align the first charging coil 60 of the terminal equipment to be charged with the second charging coil 50 of the wireless charging device.

In some embodiments of the present disclosure, the above wireless charging method further includes steps 200˜201 (S200˜S201).

In S200, it is detected whether the terminal equipment to be charged 80 is placed on the carrying platform 10 of the wireless charging device.

Here, a gravity detection sensor or a distance measuring sensor or the like may be used to detect whether the terminal equipment to be charged 80 is placed on the carrying platform 10 of the wireless charging device.

In S201, the second charging coil 50 is controlled to be energized in a case that the terminal equipment to be charged 80 is placed on the carrying platform 10. If it is detected that the terminal equipment to be charged 80 is not placed on the carrying platform 10, the second charging coil 50 is controlled to be not energized.

In a case that the second charging coil 50 is energized, the second charging coil 50 generates the magnetic field, so that the first charging coil 60 of the terminal equipment to be charged can be charged.

In some embodiments of the present disclosure, after the first charging coil 60 is aligned with the second charging coil 50, the terminal equipment to be charged 80 will be placed on the carrying platform 10 for charging. In this way, when it is detected that the terminal equipment to be charged 80 is placed on the carrying platform 10 of the wireless charging device, the second charging coil 50 can be controlled to be energized, so as to directly charging the first charging coil 60 without manual control required to energized the second charging coil 50, thereby realizing an intelligentization of the wireless charging device and improving the satisfaction of the users.

The above are merely specific implementations of the present disclosure, but the protection scope of the present disclosure is not limited thereto. Any person skilled in the art may easily think of the changes or the modifications within the technical scope disclosed by the present disclosure, which should be within the scope of the disclosure. Therefore, the protection scope of the present disclosure should be based on the protection scope of the claims.

Additional embodiments including any one of the embodiments described above may be provided by the disclosure, where one or more of its components, functionalities or structures is interchanged with, replaced by or augmented by one or more of the components, functionalities or structures of a different embodiment described above.

What is claimed is:

1. A wireless charging device, comprising:
a carrying platform configured to place a terminal equipment to be charged;
a plurality of magnetic field detection sensors distributed on a plane parallel to a bearing surface of the carrying platform, wherein the plurality of magnetic field detection sensors being configured to detect a change value of a magnetic field intensity generated by a first charging coil of the terminal equipment to be charged;
a position indicator configured to indicate a position of the first charging coil;
a controller connected to both the position indicator and the plurality of magnetic field detection sensors, wherein the controller being configured to determine the position of the first charging coil according to the change value of the magnetic field intensity detected by the plurality of magnetic field detection sensors, and to control the position indicator to indicate the position of the first charging coil; and,
a second charge coil.

2. The wireless charging device according to claim 1, wherein, the position indicator comprises a position indication layer disposed on the bearing surface of the carrying platform, and a position of the position indication layer corresponds to a position of the plurality of magnetic field detection sensors.

3. The wireless charging device according to claim 2, wherein, the position indication layer comprises a plurality of LED lamps, and a position of the plurality of LED lamps corresponds to the position of the plurality of magnetic field detection sensors.

4. The wireless charging device according to claim 3, wherein, the controller is further configured to control a brightness of light emitted from the plurality of LED lamps according to the change value of the magnetic field intensity detected by the plurality of magnetic field detection sensors.

5. The wireless charging device according to claim 1, wherein the controller is further configured to calculate a center position of the first charging coil according to the change value of the magnetic field intensity detected by the plurality of magnetic field detection sensors, and to control the position indicator to indicate the center position of the first charging coil.

6. The wireless charging device of claim 1, wherein the wireless charging device further comprises a power supply; wherein,
the power supply and the second charging coil are both connected to the controller, and the controller is further configured to control a turning-on and a turning-off of a control switch connected between the power supply and the second charging coil and to control a magnitude of a current output from the power supply to the second charging coil.

7. The wireless charging device of claim 6, wherein the power supply comprises a polymer battery.

8. The wireless charging device of claim 6, wherein the wireless charging device further comprises a detector connected to the controller, wherein the detector is configured to detect whether the terminal equipment to be charged is placed on the carrying platform; if the terminal equipment to be charged is placed on the carrying platform, the controller controls the control switch connected between the power supply and the second charging coil to be turned on.

9. The wireless charging device according to claim 1, wherein a marker is provided on the bearing surface of the carrying platform, and the marker is configured to indicate a position of the second charging coil.

10. A wireless charging method of a wireless charging device according to claim 1, comprising:
detecting a change value of a magnetic field intensity generated by a first charging coil of a terminal equipment to be charged;
determining a position of the first charging coil according to the change value of the magnetic field intensity; and
indicating the position of the first charging coil.

11. The wireless charging method according to claim 10, wherein a step of detecting the change value of the magnetic field intensity generated by the first charging coil of the terminal equipment to be charged comprises:
detecting the change value of the magnetic field intensity generated by the first charging coil in a case that a second charging coil of the wireless charging device is not energized.

12. The wireless charging method according to claim 10, wherein a step of determining the position of the first charging coil according to the change value of the magnetic field intensity comprises: determining a center position of the first charging coil according to the change value of the magnetic field intensity; and
a step of indicating the position of the first charging coil comprises: indicating the center position of the first charging coil.

13. The wireless charging method of claim 10, wherein, the wireless charging method further comprises:
detecting whether the terminal equipment to be charged is placed on the carrying platform of the wireless charging device; and
controlling the second charging coil to be energized in a case that the terminal equipment to be charged is placed on the carrying platform.
